(19) United States
(12) Patent Application Publication
(10) Pub. No.: US 2022/0207378 A1
(43) Pub. Date: Jun. 30, 2022

(54) SUPER NEURONS WITH NON-LOCALIZED KERNEL OPERATIONS

(71) Applicant: QATAR UNIVERSITY, Doha (QA)

(72) Inventors: Serkan KIRANYAZ, Doha (QA); Junaid MALIK, Tampere (FI); Turker INCE, Balcova/Izmir (TR); Moncef GABBOUJ, Tampere (FI)

(21) Appl. No.: 17/566,259

(22) Filed: Dec. 30, 2021

Related U.S. Application Data
(60) Provisional application No. 63/133,137, filed on Dec. 31, 2020.

(51) Int. Cl. G06N 3/08; G06N 3/04

(52) U.S. Cl. CPC G06N 3/084; G06N 3/04

(57) ABSTRACT

Systems, methods, apparatuses, and computer program products for a machine learning paradigm. In accordance with some example embodiments, a self-organizing network may include one or more super neuron models with non-localized kernel operations. A set of additional parameters may define a spatial bias as the deviation of a kernel from the pixel location towards x- and y-direction for a k^{th} output neuron connection to an i^{th} neuron input map at layer l+1. This spatial bias may either be randomly set or may be optimized during the BP training. In either case, the network may benefit from such “non-localized” kernels that improve the receptive field size.

### CROSS-REFERENCE TO RELATED APPLICATION

This application claims the benefit of U.S. Provisional Application No. 63/133,137, filed Dec. 31, 2020. The entire content of the above-referenced application is hereby incorporated by reference.

### TECHNICAL FIELD

Some example embodiments may generally relate to machine learning. For example, certain example embodiments may relate to systems and/or methods for a machine learning paradigm.

### BACKGROUND

The use of artificial neural networks in business and industry has wide applicability. There is an increasing rate of interest over artificial intelligence (AI) and its applications on smart devices, IoT, and other high-tech domains. Some examples include GOOGLE's self-driving car, AI-based personal assistants like Siri, and applications of deep learning. Thus, AI-based solutions are of interest to a wide variety of high-tech companies and other stakeholders.

### SUMMARY

In accordance with some example embodiments, a self-organizing network may include one or more super neuron models with non-localized kernel operations. A set of additional parameters may define a spatial bias as the deviation of a kernel from the pixel location towards x- and y-direction for the k^{th} output neuron connection to an i^{th} neuron input map at layer l+1.

### BRIEF DESCRIPTION OF THE DRAWINGS

For proper understanding of example embodiments, reference should be made to the accompanying drawings, wherein:

FIG. 1 illustrates nodal operations in the kernels of the k^{th} CNN, ONN, and self-ONN neurons at the l^{th} layer.

FIG. 2 illustrates localized versus non-localized kernel operations to create a pixel.

FIG. 3 illustrates an example of a computing device according to some example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for a machine learning paradigm is not intended to limit the scope of certain example embodiments, but is instead representative of selected example embodiments.

Operational neural networks (ONNs) include network models that address some drawbacks of conventional convolutional neural networks (CNNs). For example, homogenous network configurations with the “linear” neuron model can perform linear transformations over the previous layer outputs. ONNs can perform non-linear transformations with a proper combination of “nodal” and “pool” operators. However, ONNs may still have certain restrictions, which may be the sole usage of single nodal operators for synaptic connections of each neuron.

Generalized Operational Perceptrons (GOPs) may aim to model biological neurons with distinct synaptic connections. GOPs may provide improved diversity, encountered in biological neural networks, resulting in an elegant performance level on numerous challenging problems where conventional MLPs are unsuccessful (e.g., two-spirals or N-bit parity problems). Similar to GOPs, operational neural networks (ONNs) may act as a superset of CNNs. In addition to outperforming CNNs, ONNs may learn problems CNNs would otherwise fail. However, ONNs also exhibit various drawbacks, such as strict dependability to the operators in the operator set library, the search for an operator set for each layer/neuron, and the need for setting (i.e., fixing) the operator sets of the output layer neuron(s) in advance. Self-organized ONNs (self-ONNs) with generative neurons may address one or more of these drawbacks without any prior search or training, and/or with an elegant computational complexity. During the training of the network, in order to maximize the learning performance, each generative neuron in a S elf-ONN may customize the nodal operators of each kernel connection. This may yield a heterogeneity level that is beyond what ONNs can offer and thus, the traditional “weight optimization” of conventional CNNs may be become an “operator customization” process.

However, generative neurons may still perform “localized” kernel operations; thus, the kernel size of a neuron at a particular layer may determine the capacity of the receptive fields and the amount of information gathered from the previous layer. Using a larger-size kernel may partially address this issue. However, this may not only create an increasing complexity issue, it may also not be feasible to determine the optimal kernel size for each connection of the neuron.

Certain example embodiments described herein may have various benefits and/or advantages to overcome the disadvantages described above. For example, certain example embodiments may certain embodiments may gather information from a larger area in the previous layer maps while keeping the kernel size as is. For certain applications, certain embodiments may learn or customize the (central) locations of each connection kernel during the training process along with the customized nodal operators so that both can be optimized simultaneously. Furthermore, according to various embodiments, self-ONNs with super neurons may be a superset of CNNs with convolutional neurons, and may have an improved learning ability. Thus, certain example embodiments discussed below are directed to improvements in computer-related technology.

Certain example embodiments may provide a machine learning paradigm, and may be used in any deep learning or machine learning application. Specifically, self-ONNs with a super neuron model may be used in any application where convolutional neural networks (CNNs) are used. Non-linear and heterogeneous network, self-ONNs with super neurons may have the potential to replace the conventional CNNs for applications in various domains such as healthcare, smart devices, personal assistants, media annotations and tagging, computer vision, etc.

Certain embodiments may provide a machine learning paradigm, and may be used in any Deep Learning or Machine Learning application. Specifically, Self-ONNs with a super neuron model may be used in any application where Convolutional Neural Networks (CNNs) are used. Self-ONNs with super neurons may be a superset of CNNs with convolutional neurons, and may have an improved learning ability. Non-linear and heterogeneous networks, such as Self-ONNs with super neurons, may have the potential to replace conventional CNNs for applications in various domains such as healthcare, smart devices, personal assistants, media annotations and tagging, computer vision, etc.

Generative neurons may address the challenges described above, where each nodal operator may be customized during the training in order to maximize the learning performance. As a result, the network may self-organize the nodal operators of its neurons' connections. With Self-Organized ONNs (Self-ONNs) composed with the generative neurons, certain embodiments may achieve a level of diversity even with a compact configuration. However, because these neurons may be associated with localized kernel operations, which may impose a limitation to the information flow between layers. Thus, certain embodiments may include neurons that gather information from a larger area in the previous layer maps without increasing the kernel size. Certain embodiments may learn the kernel locations of each connection during the training process along with the customized nodal operators so that both can be optimized simultaneously. This may involve an improvement over the generative neurons to achieve the “non-localized kernel operations” for each connection between consecutive layers. Certain embodiments described herein may provide super (generative) neuron models that can accomplish this without altering the kernel sizes and that may enable diversity in terms of information flow, e.g., a particular pixel of a neuron in a layer may be created by the pixels of much larger area within the output maps of the previous layer neurons. The two models of super neurons of certain embodiments may vary on the localization process of the kernels: i) randomly localized kernels within a bias range set for each layer, ii) optimized locations of each kernel during the Back-Propagation (BP) training.

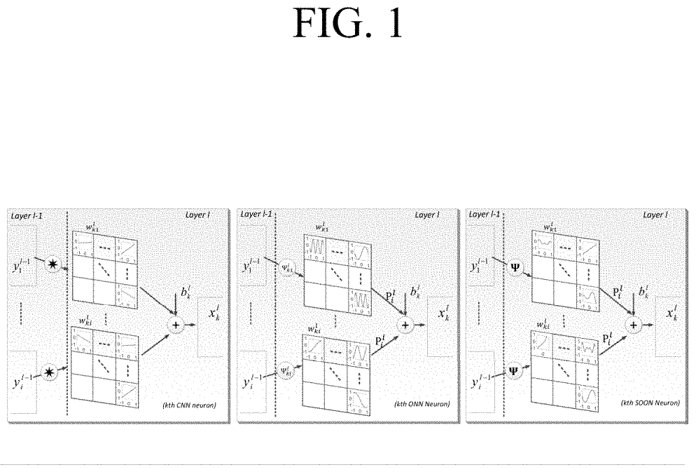

In biological neurons, during the learning process, the neurochemical characteristics and connection strengths of the synaptic connections may be altered, which may give rise to new connections and may modify the existing ones. Based on this, a generative-neuron in Self-ONNs may be formed with a composite nodal-operator for each kernel of each connection that can be generated during training without any restrictions. As a result, with such generative neurons, a Self-ONN can customize its nodal operators during training, and thus, it may have the nodal operator functions optimized by the training process to maximize the learning performance. For instance, as shown in FIG. 1, CNN and ONN neurons may have static nodal operators (linear and harmonic, respectively) for their 3×3 kernels, while the generative-neuron can have any arbitrary nodal function, Ψ (including possibly standard functions such as linear and harmonic functions), for each kernel element of each connection. This may provide flexibility that permits the formation of any nodal operator function.

Certain embodiments may provide for super neurons with non-localized kernel operations. In order to improve the receptive field size and to find a possible location for each kernel, certain embodiments may provide for non-localized kernel operations for Self-ONNs embedded in an improved neuron model to the generative neurons, which may be referred to as a super (generative) neuron. Certain embodiments may provide multiple models of super neurons that vary on the localization process of the kernels: i) randomly localized (uniformly distributed) kernels within a bias range set for each layer, ii) BP-optimized locations of each kernel. Particularly, in the latter model, what operator may be used and where it may be located, may be simultaneously optimized during the BP training. This may be more advantageous for some particular problems where certain optimal kernel locations may exist or some kernel location topology (or distribution) may be more desirable. When this is not the case, the former model with the randomized bias values can be preferable since a diverse location may be as good as any other, and thus uniformly distributed kernels within a bias range may perform as well as, or perhaps even better than, the BP-optimized kernel locations. The latter may be due to the fact that simultaneous optimization of the nodal operators and kernel locations may be significantly harder than the sole optimization of the nodal operators.

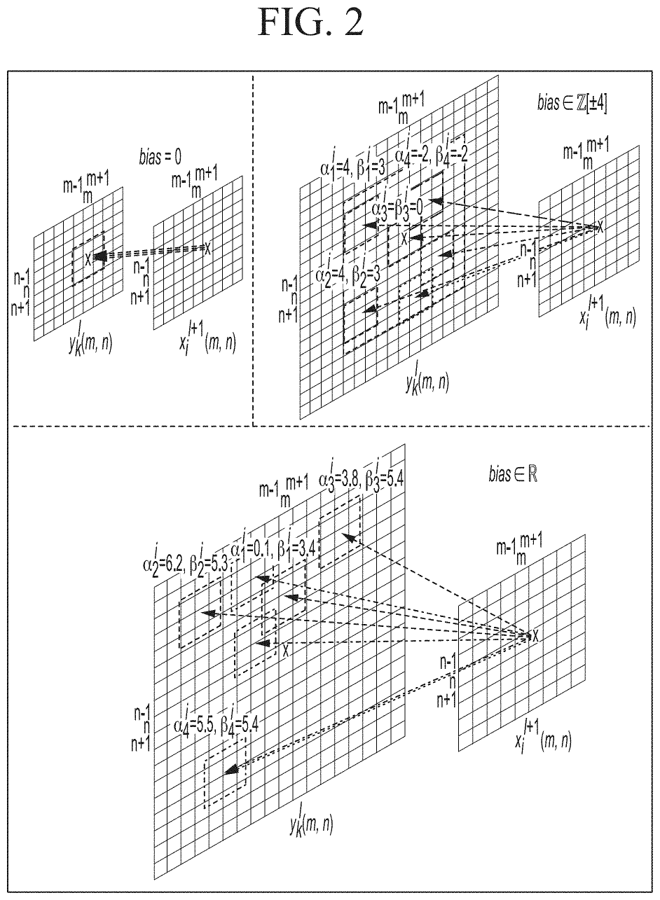

Certain embodiments may utilize a generative neuron model of Self-ONNs. Like its predecessors, each kernel connection of a neuron to the previous layer output maps may be localized, i.e., for a pixel located at (m, n) in a neuron at the current layer, kernels may be located (centered) at the same location over the previous layer output maps. As depicted in FIG. 2 a pixel of the i^{th} neuron in layer l+1, xᵢ^{l+1}(m, n) may be computed using the, e.g., 9 pixels of the previous layer output maps, yₖ^{l}(m+r, n+t)∀r, t ∈ [−1,1], for ∀k ∈ [1, Nₗ] operated with the kernels centered at the same location, (m, n), given that Nₗ may be the number of neurons in the previous layer, l. This may result in some limitations since the kernel may be blinded to the neighboring pixels which can potentially provide meaningful contribution to the input pixel, and hence may not be excluded.

Certain embodiments may provide a possible solution by providing one or more super neuron models with non-localized kernel operations as illustrated in the top-right and bottom of FIG. 2. A set of additional parameters may be defined, the spatial bias, as the deviation of the kernel from the pixel location (m, n), towards x- and y-direction for the k^{th} output neuron connection to the i^{th} neuron input map at layer l+1, represented as [αₖⁱ, βₖⁱ]. In the bottom left of FIG. 2, the 3×3 kernels may be randomly located within a bias range of [−4,4], and the pixels within the region of 11×11 pixels can contribute when they belong to the kernel of an individual connection to a particular output map. In FIG. 2, different colored kernels may be from different connections and their corresponding bias values within the 11×11 region (the outer red-dashed square) may be randomly set in advance. For instance, the bias for the 1^{st} connection (black) may be, α₁ⁱ=4, β₁ⁱ=3 pixels, whereas for the 3^{rd} connection, it may be α₁ⁱ=0, β₁ⁱ=0, respectively. Finally, in the bottom of FIG. 2, the bias values may be real numbers without any range set in advance, since they may be iteratively optimized by the BP training along with other network parameters. At the end of the training, they may be expected to converge to a (local) optimum point. The bottom of FIG. 2 illustrates the instantaneous bias values for some connections at a particular BP epoch.

To obtain such a non-localized kernel for the i^{th} neuron in layer l+1, connected to the k^{th} neuron in layer l with integer bias in x- and y-directions, αₖⁱ and βₖⁱ, respectively. Let T^{(α}^{ₖ}^{ⁱ}^{,β}^{ₖ}^{ⁱ}⁾ be the shift operator for yₖ^{l} by the bias, [αₖⁱ, βₖⁱ]. Certain embodiments may perform the shift to obtain yₖ^{l}(m+αₖⁱ, n+βₖⁱ), and then operate with the original Kx×Ky kernel, wᵢₖ^{l+1}. For generative neurons of Self-ONNs, recall that Ψ may be the composite nodal function which may be the Q^{th} order Mac-Laurin series.

Various example embodiments may include a generative neuron model, including super neurons which may be an artificial neuron with a composite nodal-operator that can be generated during training without any restrictions, and/or can seek for the right (kernel) location of each connection. As a result, super-neurons may be jointly optimized to do the right transformation at the right (kernel) location of the right connection to maximize the learning performance. Furthermore, self-ONNs, as a heterogeneous network model based on this new neuron model, may be included in certain embodiments, which may have an improved diversity and learning capability compared to homogenous (linear) network model of CNNs, conventional ONNs and Self-ONNs with generative neurons. A stochastic gradient-descent (Back-Propagation) training method may be formulated with certain implementation features. The results over various challenging problems may demonstrate that Self-ONNs not only out-perform CNNs and Self-ONNs, but may be able to learn those problems where the CNNs entirely fail.

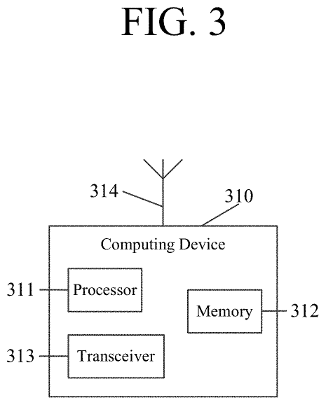

FIG. 3 illustrates an example of a system according to certain example embodiments. In one example embodiment, a system may include, for example, computing device 310.

Computing device 310 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof.

Computing device 310 may include at least one processor, indicated as 311. Processors 311 may be embodied by any computational or data processing device, such as a central processing unit (CPU), application specific integrated circuit (ASIC), or comparable device. The processors may be implemented as a single controller, or a plurality of controllers or processors.

At least one memory may be provided in computing device 310, as indicated at 312. The memory may be fixed or removable. The memory may include computer program instructions or computer code contained therein. Memory 312 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processor 311, memory 312, and any subset thereof, may be configured to provide means corresponding to the various techniques discussed above and illustrated in FIGS. 1-2. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 3, transceiver 313 may be provided, and one or more devices may also include at least one antenna, respectively illustrated as 314. The device may have many antennas, such as an array of antennas configured for multiple input multiple output (MIMO) communications, or multiple antennas for multiple RATs. Other configurations of these devices, for example, may be provided. Transceiver 313 may be a transmitter, a receiver, both a transmitter and a receiver, or a unit or device that may be configured both for transmission and reception.

The memory and the computer program instructions may be configured, with the processor for the particular device, to cause a hardware apparatus, such as UE, to perform any of the techniques described above (i.e., FIGS. 1-2). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the techniques discussed above and illustrated in FIGS. 1-2. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

According to certain example embodiments, processor 311 and memory 312 may be included in or may form a part of processing circuitry or control circuitry. In addition, in some example embodiments, transceiver 313 may be included in or may form a part of transceiving circuitry.

In some example embodiments, an apparatus (e.g., computing device 310) may include means for performing a method, a process, or any of the variants discussed herein. Examples of the means may include one or more processors, memory, controllers, transmitters, receivers, and/or computer program code for causing the performance of the operations.

In various example embodiments, computing device 310 may be controlled by processor 311 and memory 312 to perform various techniques discussed above and illustrated in FIGS. 1-2.

Certain example embodiments may be directed to an apparatus that includes means for performing any of the methods described herein including, for example, means for performing various techniques discussed above and illustrated in FIGS. 1-2.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

AI Artificial Intelligence

BP Back Propagation

CNN Convolutional Neural Network

GOP Generalized Operational Perceptron

MLP Machine Learning Paradigm

ONN Operational Neural Network

We claim:

1. A self-organizing network configured to perform operations on a computing device comprising at least one processor and at least one memory, comprising:
one or more super neuron models with non-localized kernel operations, wherein
a set of additional parameters defines a spatial bias as the deviation of a kernel from the pixel location towards x- and y-direction for a k^{th} output neuron connection to an i^{th} neuron input map at layer l+1.

2. The self-organizing network of claim 1, wherein the non-localized kernel for the i^{th} neuron in layer l+1 is connected to the k^{th} neuron in layer l with integer bias in x- and y-directions, αₖⁱ and βₖⁱ, respectively.

3. The self-organizing network of claim 1, further comprising:
one or more generative neuron models configured to perform non-localized kernel operations without altering the kernel sizes and will enable a significant diversity in terms of information flow.

4. The self-organizing network of claim 3, wherein the one or more generative neuron models are configured to generate at least one particular pixel of a neuron in a layer associated with pixels of a larger area from at least one output map of at least one previous layer neuron.

5. The self-organizing network of claim 4, wherein a location process of the one or more generative neuron models is based upon at least one of:
at least one randomly localized kernel within a bias range set for each layer; and
at least one location of each kernel optimized during back-propagation training.

6. The self-organizing network of claim 5, wherein at least one randomly localized kernel is configured to optimize at least one nodal operator with respect to at least one spatial bias initially set randomly.

7. The self-organizing network of claim 6, wherein at least one location of each kernel is configured to jointly optimize the nodal operator and at least one spatial bias during at least one back-propagation procedure.

8. The self-organizing network of claim 7, wherein at least one back-propagation procedure is configured performed based upon at least one non-integer bias values.
